(19) United States
(12) Patent Application Publication
(10) Pub. No.: US 2023/0077417 A1
(43) Pub. Date: Mar. 16, 2023

(54) MODEL MANAGEMENT APPARATUS, MODEL CORRECTION METHOD AND PROGRAM

(71) Applicant: Nippon Telegraph and Telephone Corporation, Tokyo (JP)

(72) Inventors: Naoki HANAOKA, Musashino-shi, Tokyo (JP); Hidetoshi TAKADA, Musashino-shi, Tokyo (JP)

(21) Appl. No.: 17/798,668

(22) PCT Filed: Feb. 12, 2020
(86) PCT No.: PCT/JP2020/005384

§ 371 Date: Aug. 10, 2022

(51) Int. Cl. G06F 30/36

(52) U.S. Cl. CPC G06F 30/36; G06F 2113/04

(57) ABSTRACT

A model management apparatus for managing a power grid model having, as a model value, a parameter of a power grid connecting a plurality of sites includes: a storage unit configured to store the model value; a monitoring unit configured to acquire a measured value from each site in the power grid; and a model correction unit configured to calculate a parameter in the power grid based on the measured value obtained from the monitoring unit, and correct the model value using the calculated parameter.

### TECHNICAL FIELD

The present invention relates to a technique for calculating parameters in a power grid.

### BACKGROUND ART

At sites such as data centers and communication buildings, in addition to receiving power from commercial power sources via a power distribution grid and supplying the power to consumer equipment, a power generation unit using natural energy obtained through photovoltaic power generation (PV: photovoltaics) or the like is often provided such that the power generated by the power generation unit is used. Furthermore, a power storage unit (storage battery) is often provided as a preparation for disasters and the like.

Furthermore, in recent years, there are cases in which the power of a site at which there is surplus power is transferred to another site, by connecting a plurality of sites with a private distribution line (a power grid prepared separately from the AC power distribution grid).

### CITATION LIST

### Non Patent Literature

[NPL 1] Innovation in Power Distribution Business using Next Generation Technique (TEPCO Power Grid, Incorporated) https://www.meti.go.jp/shingikai/energy_environment/denryoku_p latform/pdf/004_03_00.pdf

### SUMMARY OF THE INVENTION

### Technical Problem

When surplus power is distributed from one site to another via a private distribution line, distribution loss occurs in proportion to the distribution distance, and thus the distributed surplus power may be impaired by the distribution loss and cannot be used effectively on the other side depending on the distribution distance and the like. Therefore, it is conceivable to calculate the distribution loss according to the distribution distance in advance, and to transfer the power to another site in the case in which surplus power is larger than power that will be impaired by the distribution loss. Although NPL 1 describes that the distributable capacity is calculated, there is no description that the distribution loss is calculated.

In order to calculate the distribution loss correctly, it is necessary to accurately obtain parameters in the power grid, such as a resistance value of a cable connecting sites. Parameters such as a resistance value can be calculated as theoretical values based on the cable length and the like. However, in the theoretical values, a fluctuation due to resistance components (a connection unit and a protection device) other than the cable and an increase in the resistance due to deterioration cannot be taken into consideration, and the accuracy of distribution loss calculation is lowered. If the accuracy is low, it becomes impossible to efficiently control the power transfer and the like.

The problem that parameters of a power grid cannot be accurately obtained is not limited to cases in which the parameters are resistance values or the power transfer is to be controlled.

The present invention has been made in view of the above-described aspects, and it is an object thereof to provide a technique capable of accurately calculating parameters in a power grid.

### Means for Solving the Problem

According to the disclosed technique, a model management apparatus is provided for managing a power grid model having, as a model value, a parameter of a power grid connecting a plurality of sites, including: a storage unit configured to store the model value; a monitoring unit configured to acquire a measured value from each site in the power grid; and a model correction unit configured to calculate a parameter in the power grid based on the measured value obtained from the monitoring unit, and correct the model value using the calculated parameter.

### Effects of the Invention

According to the disclosed technique, it is possible to provide a technique for accurately calculating a parameter in a power grid.

### BRIEF DESCRIPTION OF DRAWINGS

FIG. 1 is a diagram showing an example of a microgrid.

FIG. 2 is a diagram showing a site A and a site B.

FIG. 3 is a configuration diagram of a model management apparatus.

FIG. 4 is a diagram showing a hardware configuration example.

FIG. 5 is a flowchart illustrating an operation example of the model management apparatus.

FIG. 6 is a diagram showing an example of a route specified in S102.

FIG. 7 is a diagram showing an example of data acquired from the site A and the site B.

FIG. 8 is a diagram showing an example of a model value between the site A and the site B.

FIG. 9 is a diagram showing an example of a method for calculating a correction value.

### DESCRIPTION OF EMBODIMENTS

Hereinafter, embodiments of the present invention will be described with reference to the drawings. The embodiments described below are merely examples, and the embodiments to which the present invention is applied are not limited to the following embodiments.

(System Configuration)

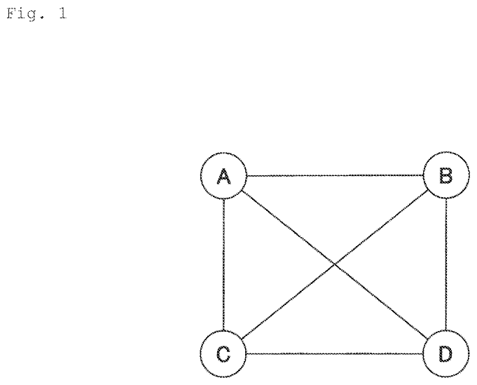

In this embodiment, for example, a microgrid as shown in FIG. 1 is assumed as a power grid that is to be controlled. The microgrid shown in FIG. 1 has four sites A to D that are connected to each other by a cable (distribution line), and power can be transmitted and received (transferred) between the sites.

Each site is assumed to be a building such as a communication building or a data center, but such an assumption is an example. The “site” may be in a narrower range than the building (e.g., one floor, one room, etc.), and the “site” may be in a wider range than the building (e.g., a building group, a town, a city, a prefecture, a region, etc.).

In this embodiment, power is transmitted and received in the form of DC between sites, so the microgrid in FIG. 1 may be referred to as a DC microgrid. The technique according to the present invention is applicable not only to DC but also to AC.

The actual power grid is not as simple as shown in FIG. 1, but there are various constituent elements, and the sites are connected by routes with various shapes. FIG. 1 is an abstraction and modeling of an actual power grid. The power grid modeled in this way is referred to as a “virtual power grid model”. The “virtual power grid model” may be referred to as a “power grid model”.

The virtual power grid model includes topology information indicating connection between sites as shown in FIG. 1, site information of each site (e.g., information on equipment (a power generation unit, a power storage unit, consumer equipment, etc.)), site-to-site information (e.g., a cable distance, diameter, etc.), and various parameters (e.g., a resistance value between sites, etc.). Since the parameter is a value that constitutes the model, it may be referred to as a model value. By referring to the virtual power grid model, for example, the distribution loss between sites can be easily calculated.

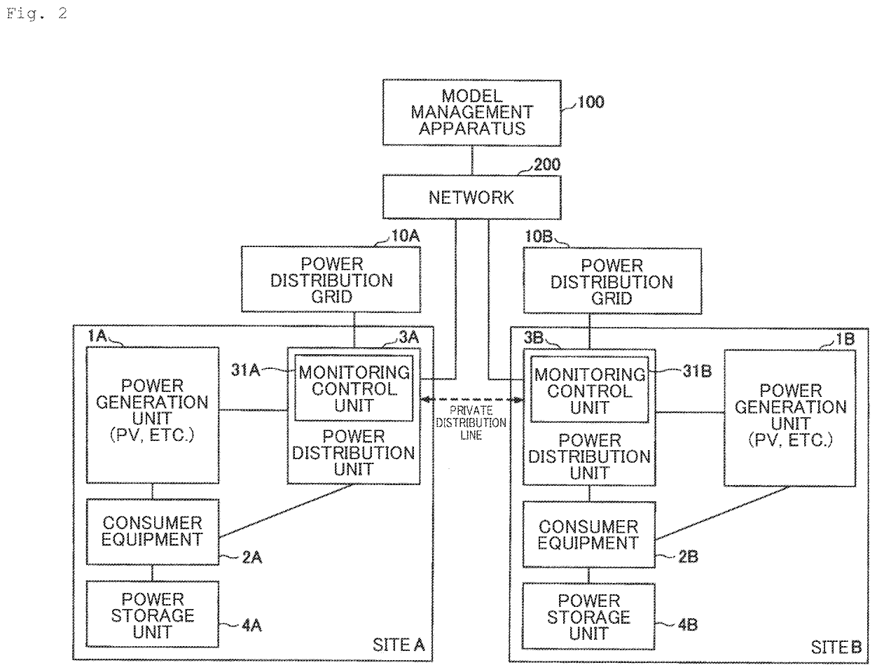

FIG. 2 shows a configuration example relating to a site A and a site B, which are examples of a plurality of sites constituting the microgrid. As shown in FIG. 2, the site A and the site B are connected by a private distribution line.

As shown in FIG. 2, the site A includes a power generation unit 1A configured to generate power with natural energy such as sunlight, consumer equipment 2A that is a load configured to consume power, a power storage unit 4A that includes a storage battery configured to store power, and a power distribution unit 3A connected to a power distribution grid 10A provided by an electric power company. The power storage unit 4A may be an EV (electric vehicle). An EV may be connected in addition to the power storage unit 4A.

The power generation unit 1A and the power storage unit 4A each include a DC/DC converter (hereinafter referred to as a converter). The power distribution unit 3A that receives commercial power includes a rectifier and a converter. A portion (rectifier+converter) that receives commercial power from the AC power distribution grid 10 and supplies it to a site may be referred to as a commercial power source.

The consumer equipment 2A is, for example, a network device such as a router, a server that processes data, or the like. The consumer equipment 2A may be a server that operates a virtual machine. The site B also has the same configuration as the site A.

The power distribution unit 3A can receive the power (commercial power) supplied from the power distribution grid 10A and supply the received power to the consumer equipment 2A and the power storage unit 4A. Further, for example, when the power generated by the power generation unit 1A is larger than the power consumed by the consumer equipment 2A, the power distribution unit 3A can distribute the surplus power to the power distribution grid 10A or another site. On the contrary, the power distribution unit 3A can also receive power from another site (e.g., the site B) and supply the power to the consumer equipment 2A and the power storage unit 4A. Supplying power from one site to another can be referred to as “transfer” of power.

As shown in FIG. 2, a model management apparatus 100 is provided. The power distribution unit 3A of the site A has a monitoring control unit 31A including a voltmeter, an ammeter, an electric energy meter, and the like, and the power distribution unit 3A having the monitoring control unit 31A is communicably connected to the model management apparatus 100 via a network 200. The same applies to the site B.

For example, when distributing power from the site A to the site B, the model management apparatus 100 can acquire the voltage of the site A from the monitoring control unit 31A of the site A and the voltage of the site B from the monitoring control unit 31B of the site B. Further, the model management apparatus 100 can acquire the current value from each of the monitoring control unit 31A of the site A and the monitoring control unit 31B of the site B.

Although the sites A and B are shown as sites in FIG. 2, for example, as shown in FIG. 1, there are actually a larger number of sites, and each site is connected to the model management apparatus 100 via the network 200. Furthermore, although the model management apparatus 100 is provided outside the site A and the site B in the example shown in FIG. 2, the model management apparatus 100 may be provided in one of the sites (e.g., the site A), and the sites may be connected to each other by a communication network. The model management apparatus 100 provided at the site (e.g., the site A) can acquire the measured values of other sites through this communication network. Furthermore, there may be a site that does not have a power generation unit.

Hereinafter, the apparatus configuration and processing procedure will be described in more detail.

(Apparatus Configuration)

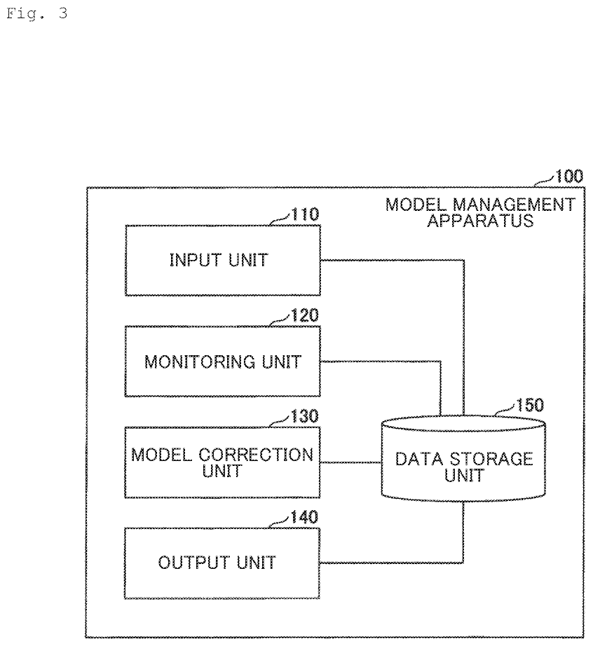

FIG. 3 shows a functional configuration diagram of the model management apparatus 100. As shown in FIG. 3, the model management apparatus 100 includes an input unit 110, a monitoring unit 120, a model correction unit 130, an output unit 140, and a data storage unit 150.

The input unit 110 receives input of virtual power grid model information (topology information, site information, site-to-site information, various parameters), and stores these pieces of information in the data storage unit 150 as a virtual power grid model. The parameters input from the input unit 110 are initial values, and are corrected at any time through correction described later.

The monitoring unit 120 acquires measured values (information that can change dynamically) of current, voltage, and the like from the monitoring control unit 31 of each site, and stores them in the data storage unit 150.

The model correction unit 130 calculates parameters based on the information acquired by the monitoring unit 120 and corrects the model values of the virtual power grid model. For example, the model correction unit 130 calculates a resistance component from the current and the potential difference between the sites, compares it with the existing model value, and corrects the model value of the virtual power grid model if there is a difference therebetween. Details of the processing of the model correction unit 130 will be described later. The output unit 140 outputs a virtual power grid model having corrected parameters.

### Hardware Configuration Example

The model management apparatus 100 can be realized, for example, by causing a computer to execute a program describing the processing contents described in this embodiment. The “computer” may be a virtual machine on the cloud. When using a virtual machine, the “hardware” described here is virtual hardware.

The above-mentioned program can be recorded on a computer-readable recording medium (portable memory, etc.), saved, and distributed. It is also possible to provide the above-mentioned program through a network such as the Internet or e-mail.

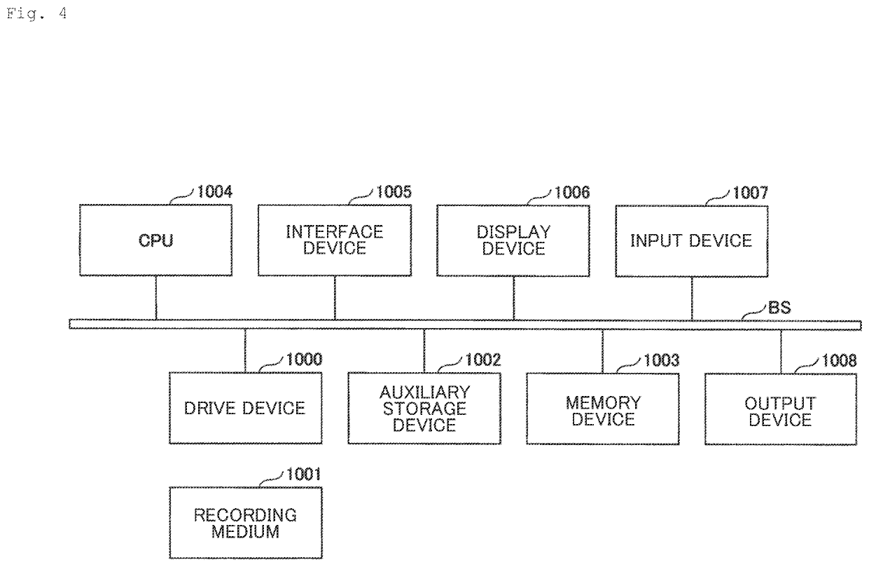

FIG. 4 is a diagram showing a hardware configuration example of the above-mentioned computer. The computer in FIG. 4 has a drive device 1000, an auxiliary storage device 1002, a memory device 1003, a CPU 1004, an interface device 1005, a display device 1006, an input device 1007, an output device 1008, and the like that are connected to each other via a bus BS.

The program that realizes the processing on the computer is provided by, for example, a recording medium 1001 such as a CD-ROM or a memory card. When the recording medium 1001 storing the program is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 realizes the function related to the model management apparatus 100 according to the program stored in the memory device 1003. The interface device 1005 is used as an interface for connecting to a network. The display device 1006 displays a programmatic GUI (graphical user interface) or the like. The input device 1007 is constituted by a keyboard, a mouse, buttons, a touch panel, and the like, and is used for inputting various operation instructions. The output device 1008 outputs the calculation result and the like.

### Operation Example of Model Management Apparatus 100

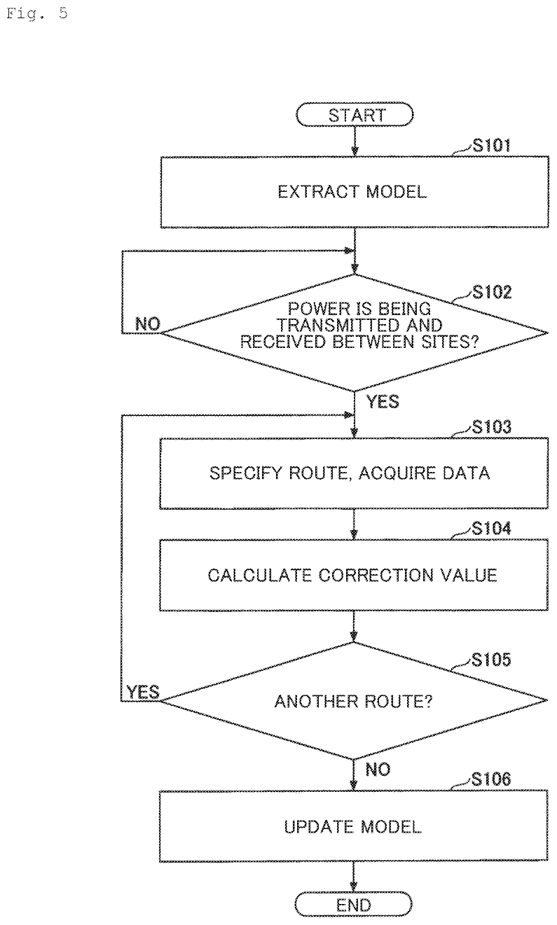

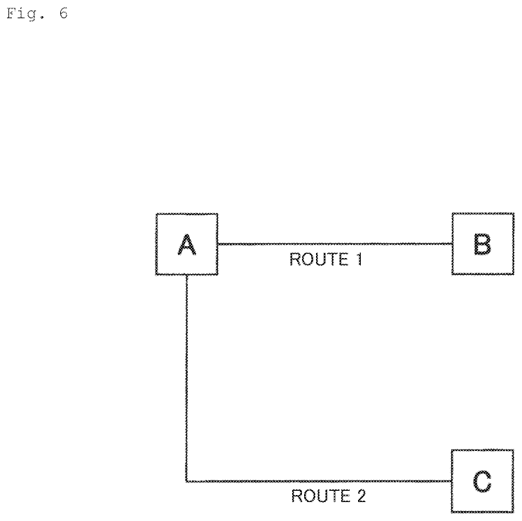

Next, an operation example of the model management apparatus 100 will be described with reference to the flowchart in FIG. 5. Here, for example, it is assumed that a virtual power grid model as shown in FIG. 6 is already stored in the data storage unit 150.

In S101, the target virtual power grid model is extracted from the data storage unit 150. In S102, the monitoring unit 120 determines whether or not power is being transmitted and received between the sites in the virtual power grid model. Since the monitoring unit 120 constantly monitors the voltage of each site and the current value flowing to another site (a current value received from another site when viewed from the receiving side) from the monitoring control unit 31 of each site, the monitoring unit can determine whether or not power is being transmitted and received between sites in the power grid of the virtual power grid model.

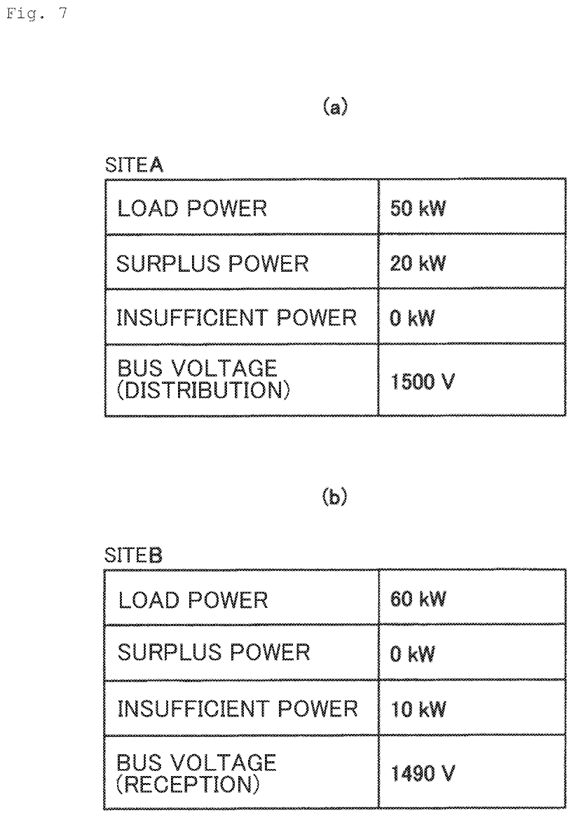

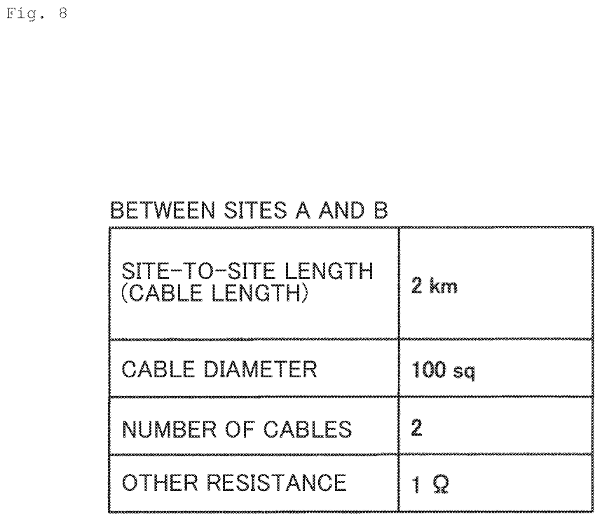

As an example, FIG. 7 shows an example of measured values acquired by the monitoring unit 120 for the site A and the site B. In addition to those shown in the drawing, for example, if a current is flowing from the site A to the site B, the current value can also be acquired. FIG. 8 shows site-to-site information between the site A and the site B.

If the determination result in S102 in FIG. 5 is Yes (power is being transmitted and received), the procedure advances to S103. Here, it is assumed that power is being transmitted and received on a route 1 (a route between the site A and the site B) in the virtual power grid model shown in FIG. 6.

In S103, the model correction unit 130 specifies the route 1 (the route between the site A and the site B) as a route on which power is being transmitted and received, based on the information from the monitoring unit 120, and acquires the measured value related to the power transmitted and received (a potential difference between the sites, a current value, etc.).

In S104, the model correction unit 130 calculates a parameter (a model correction value) based on the measured value acquired in S103. An example of calculation will be described later.

In S105, the model correction unit 130 determines whether or not there is another route as a route on which power is being transmitted and received, based on the information from the monitoring unit 120, and performs the processing of S103 and S104 on that route to calculate the parameter if the determination result is Yes. For example, in the virtual power grid model shown in FIG. 6, if the monitoring unit 120 detects that power is being transmitted and received in a route 2 in addition to route 1, S103 and S104 are performed on the route 2 to calculate the parameter.

If the determination result in S105 is No (there is no other route on which power is being transmitted and received), the procedure advances to S106. In S106, the model value of the virtual power grid model is updated using the parameter obtained in S104.

The processing of the flowchart shown in FIG. 5 may be executed periodically, or the loop returning to S101 when S106 is completed may be always repeated.

Also, regarding the route for which the parameter calculation is to be performed, when calculating the parameter on one route, it is desirable that power is not being transmitted and received on the other routes. Therefore, in the determination of S102, if the monitoring unit 120 determines that power is being transmitted and received on one route and power is not being transmitted and received on the other routes, the procedure may advance to S103 and S104 where the parameter for the route on which power is being transmitted and received is calculated.

The updated virtual power grid model information is stored in the data storage unit 150 and is acquired from the output unit 140. The output information can be used, for example, to determine deterioration of equipment.

### Example of Model Correction Value Calculation

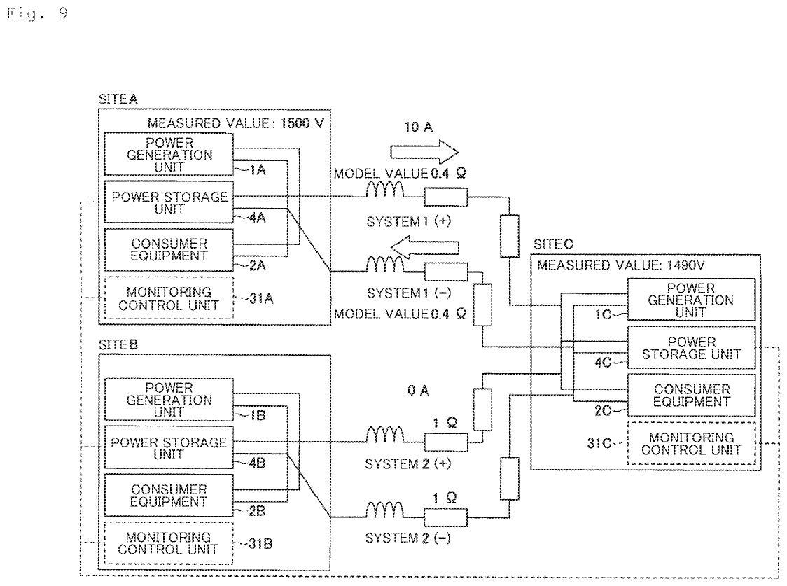

A specific example of calculating the model correction value will be described with reference to FIG. 9. FIG. 9 shows an example of a virtual power grid model including a site A, a site B, and a site C. As shown in FIG. 9, each site is provided with a power generation unit 1, a power storage unit 4, and consumer equipment 2. The sites are also provided with a monitoring control unit 31.

In the example in FIG. 9, there is a system 1 that is a route on which power is transmitted and received between the site A and the site C, and a system 2 that is a route on which power is transmitted and received between the site B and the site C. The model value of the resistance on the + side of the system 1 is 0.4Ω, and the model value of the resistance on the − side of the system 1 is 0.4Ω. The model values here may be theoretical values obtained from the diameter, the length, or the like of the cable, or may be a corrected value obtained in the previous correction.

It is assumed that the monitoring unit 120 acquires 10 A as a measured value of the DC from the site A to the site C, acquires 1500 V as a measured value of the voltage of the site A, and acquires 1490 V as a measured value of the voltage of the site C.

The model correction unit 130 calculates 10 V (1500 V-1490 V) as a voltage drop when a DC of 10 A is caused to flow from the site A to the site C based on the above-described measured values. When the voltage drop is taken as ΔV, the resistance value is taken as R, and the current value is taken as I, the model correction unit 130 calculates the resistance value 0.5Ω, from R=10 V/(10 A×2)=0.5Ω based on the relationship of ΔV=2×R×I.

Since the model value is 0.4Ω, there is a difference of 0.1Ω compared with the resistance value of 0.5Ω based on the above-described actual measurement. That is to say, it can be seen that there is a resistance component of 0.1Ω that has not been considered so far with respect to the model value of 0.4Ω. Therefore, the model correction unit 130 adds 0.1Ω to the current model value of 0.4Ω (+ side and − side respectively) of the resistance value, which is one of the parameters of the route between the site A and the site C, and obtains 0.5Ω as an updated model value.

In the above-described example, the correction of the resistance value between the sites is shown as an example of the correction of the model parameter, but the correction of the model parameter can be performed without being limited to the resistance value. For example, it is also possible to correct the impedance value.

As an example, a case in which the impedance value between the site A and the site B is corrected will be described. The monitoring control units 31A and 31B of the site A and the site B are respectively provided with devices (referred to as impedance measuring instruments) for measuring the impedance value between the sites. The impedance measuring instruments are, for example, network analyzers, but are not limited to network analyzers. When a network analyzer is used as the impedance measuring instruments, the impedance value may be measured after a power failure is caused to occur between the sites as necessary.

The monitoring unit 120 acquires the impedance value between the site A and the site B by acquiring the impedance value measured by the impedance measuring instrument from the site A or the site B. The model correction unit 130 compares the impedance value already used as the model value with the latest impedance value, and updates the model value with the latest impedance value if there is a difference therebetween.

### Effects and Summary of the Invention

According to this embodiment, parameters including factors that are difficult to estimate, such as manufacturing variations and deterioration of equipment constituting the power grid, contact resistance of the terminal block, and wiring resistance in the device, can be accurately calculated, and the calculated parameters can be reflected as model values of the virtual power grid model. As a result, more efficient power control can be realized.

This specification describes at least the model management apparatus, the model correction method, and the program described in the following notes.

### (Note 1)

A model management apparatus for managing a power grid model having, as a model value, a parameter of a power grid connecting a plurality of sites, including: a storage unit configured to store the model value; a monitoring unit configured to acquire a measured value from each site in the power grid; and a model correction unit configured to calculate a parameter in the power grid based on the measured value obtained from the monitoring unit, and correct the model value using the calculated parameter.

### (Note 2)

The model management apparatus according to note 1, wherein, in a case in which the monitoring unit detects that power is being transmitted and received between sites, the model correction unit corrects a model value between the sites.

### (Note 3)

The model management apparatus according to note 1 or 2, wherein the parameter is a resistance value between sites, and the model correction unit calculates a resistance value from a measured value of a voltage drop between the sites and a measured value of a current flowing between the sites.

### (Note 4)

The model management apparatus according to note 1 or 2, wherein the parameter is an impedance value between sites, the monitoring unit acquires an impedance value from an impedance measuring instrument that measures the impedance value between the sites, and the model correction unit corrects a model value using the impedance value.

### (Note 5)

A model correction method performed by a model management apparatus for managing a power grid model having, as a model value, a parameter of a power grid connecting a plurality of sites, the model management apparatus including a storage unit configured to store the model value, including: a monitoring step of acquiring a measured value from each site in the power grid; and a model correction step of calculating a parameter in the power grid based on the measured value obtained in the monitoring step, and correcting the model value using the calculated parameter.

### (Note 6)

A program for causing a computer to function as each unit of the model management apparatus according to any one of notes 1 to 4.

Although the present embodiment has been described above, the present invention is not limited to such a specific embodiment, and various modifications and changes can be made within the scope of the gist of the present invention described in the claims.

### REFERENCE SIGNS LIST

1A, 1B, 1C Power generation unit
2A, 2B, 2C Consumer equipment
3A, 3B, 3C Power distribution unit
10A, 10B Power distribution grid
31A, 31B, 31C Monitoring control unit
100 Power management apparatus
100 Model management apparatus
110 Input unit
120 Monitoring unit
130 Model correction unit
140 Output unit
150 Data storage unit
200 Network
1000 Drive device
1001 Recording medium
1002 Auxiliary storage device
1003 Memory device
1004 CPU
1005 Interface device
1006 Display device
1007 Input device
1008 Output device

1. A model management apparatus for managing a power grid model having, as a model value, a parameter of a power grid connecting a plurality of sites, the model management apparatus comprising:
a memory configured to store the model value;
a monitor configured to acquire a measured value from each site in the power grid; and
a processor configured to calculate the parameter in the power grid based on the measured value obtained from the monitoring unit, and correct the model value using the calculated parameter.

2. The model management apparatus according to claim 1, wherein, in a case in which the monitoring unit detects that power is being transmitted and received between sites, the processor corrects a model value between the sites.

3. The model management apparatus according to claim 1, wherein the parameter is a resistance value between sites, and the processor calculates the resistance value from a measured value of a voltage drop between the sites and a measured value of a current flowing between the sites.

4. The model management apparatus according to claim 1, wherein the parameter is an impedance value between sites, the monitor acquires an impedance value from an impedance measuring instrument that measures the impedance value between the sites, and the processor corrects the model value using the impedance value.

5. A model correction method performed by a model management apparatus for managing a power grid model having, as a model value, a parameter of a power grid connecting a plurality of sites, the model management apparatus including a storage unit configured to store the model value, the method comprising:
acquiring a measured value from each site in the power grid; and
calculating the parameter in the power grid based on the measured value, and correcting the model value using the calculated parameter.

6. A non-transitory computer readable medium storing a program comprising instructions that, upon execution, cause a computer to perform operations for managing a power grid model having, as a model value, a parameter of a power grid connecting a plurality of sites, the operations comprising:
acquiring a measured value from each site in the power grid; and
calculating the parameter in the power grid based on the measured value, and correcting the model value using the calculated parameter.
